(19) United States
(12) Patent Application Publication
(10) Pub. No.: US 2009/0312070 A1
(43) Pub. Date: Dec. 17, 2009

(54) PORTABLE ELECTRONIC DEVICE

(75) Inventors: GENG-LIANG ZHANG, Shenzhen City (CN); YONG-JUN DENG, Shenzhen City (CN); SHIH-FANG WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/481,561

(22) Filed: Jun. 9, 2009

(30) Foreign Application Priority Data
Jun. 13, 2008 (CN) 200810302130.5

(51) Int. Cl. H04M 1/00; H02H 1/00

(52) U.S. Cl. 455/572; 361/1

(57) ABSTRACT

A portable electronic device includes an enclosure, at least one pressure monitor, a battery, a working component, and a power management module. The at least one pressure monitor is used for detecting a pressure value from the surroundings and generating a detecting signal when the detected pressure value is larger than or equal to a predetermined pressure value. The battery supplies electrical power to the working component. The power management module manages the battery to supply electrical power to the working component and cuts off electrical power from the battery to the working component when receiving the detecting signal.

### BACKGROUND

1. Technical Field

The present disclosure relates to electronic devices, and particularly to a portable electronic device.

2. Description of Related Art

Commonly, many users like to carry all kinds of portable electronic devices, such as handsets, digital cameras, etc., along with them so as to conveniently use the electronic devices. If a portable electronic device is powered on and it is accidentally dropped in water, the portable electronic device may be damaged due to short-circuiting caused by the water.

Therefore, there is room for improvement within the art.

### BRIEF DESCRIPTION OF THE DRAWINGS

FIG. 1 is a pictorial representation of a portable electronic device in accordance with an exemplary embodiment.

FIG. 2 is a block diagram of the portable electronic device in FIG. 1.

### DETAILED DESCRIPTION

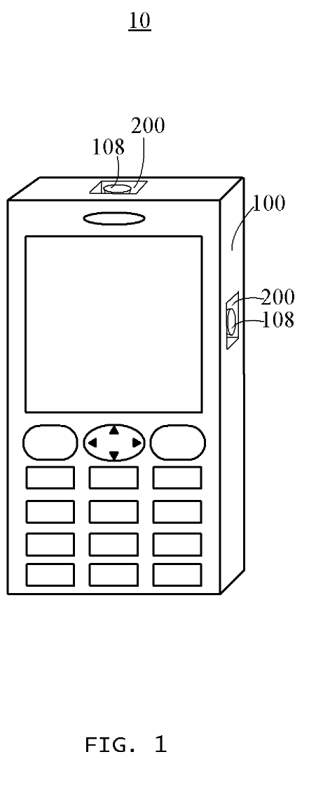

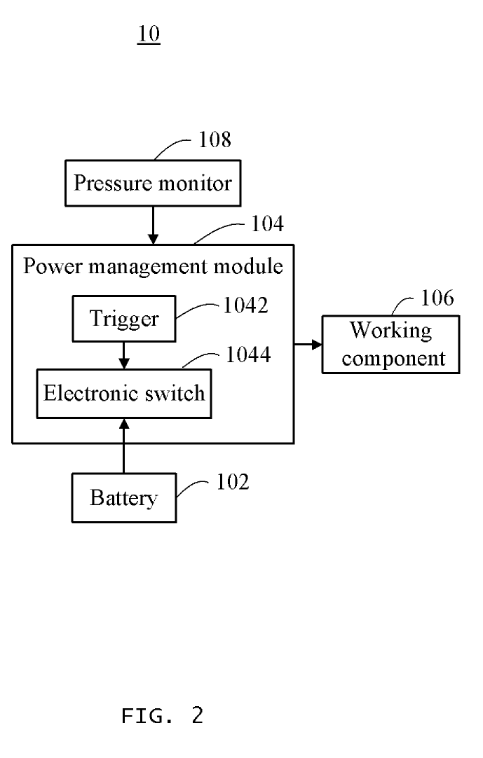

Referring to FIGS. 1 and 2, a portable electronic device 10, such as a mobile phone, has a substantially cubical enclosure 100. The enclosure 100 has a plurality of sidewalls, each of which defines a receiving portion 200 in a center thereof.

The portable electronic device 10 further includes a battery 102, a working component 106, a power management module 104 in the enclosure 100, and a plurality of pressure monitors 108. The battery 102, the working component 106, and the pressure monitors 108 electrically connect with the power management module 104. The working component 106 may be any kind of electrical component, such as, a printed circuit board, or a chipset, or a display.

The pressure monitor 108 is mounted in the receiving portion 200 of the enclosure 200 for detecting a pressure value from the surroundings, and generating a detecting signal to the power management module 104 when the pressure value is detected to be larger than or equal to a predetermined pressure value.

The power management module 104 is used for managing electrical power supplied from the battery 102 to the working component 106. The power management module 104 cuts off electrical power from the battery 102 to the working component 106 when receiving the detecting signal. The power management module 104 includes a trigger 1042 and an electronic switch 1044 electrically connecting with the trigger 1042.

The electronic switch 1044 has two states, i.e. an open state and a close state. When the electronic switch 1044 is in the close state, the electronic switch 1044 closes an electrical circuit between the battery 102 and the working component 106, i.e., when the electronic switch 1044 is in the close state, an electrical connection between the battery 102 and the working component 106 is established. In the open state, the electrical connection between the battery 102 and the working component 106 is discontinued.

The trigger 1042 is used for generating a close trigger signal to the electronic switch 1044 when receiving the detecting signal, thus the electronic switch 1044 changes from the close state to the open state.

According to the above description, when the portable electronic device 10 is dropped in water, the pressure monitor 108 detects a pressure value from the surrounding water, and generates the detecting signal when the pressure value is detected to be larger than or equal to the predetermined value. The power management module 104 cuts off electrical power from the battery 102 to the working component 106 when receiving the detecting signal. Therefore, damage to the working component 106 caused by the water is decreased.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A portable electronic device comprising:
an enclosure;
at least one pressure monitor mounted in the enclosure, the at least one pressure monitor capable of detecting a pressure value from the surroundings and generating a detecting signal when the pressure value is detected to be larger than or equal to a predetermined pressure value;
a working component mounted in the enclosure;
a battery for supplying electrical power; and
a power management module electrically connected with the battery, the working component, and the at least one pressure monitor, the power management module capable of managing the electrical power provided by the battery to the working component;
wherein the power management module cuts off the electrical power supplied to the working component when receiving the detecting signal.

2. The portable electronic device according to claim 1, wherein: the power management module comprises a trigger and an electronic switch; the electronic switch has an open state and a close state; when the electronic switch is in the close state, an electrical connection between the battery and the working component is established; and when the electronic switch is in the open state, the electrical connection between the battery and the working component is discontinued.

3. The portable electronic device according to claim 2, wherein the trigger generates a close trigger signal to the electronic switch when receiving the detecting signal and the electronic switch then changes from the close state to the open state when receiving the close trigger signal.

4. The portable electronic device according to claim 1, wherein: the electronic device is substantially cubical; the number of pressure monitor is four; and the four pressure monitors are arranged on four sidewalls of the enclosure correspondingly.

5. The portable electronic device according to claim 1, wherein the working component is a printed circuit board.

6. A mobile phone comprising:
a pressure monitor detecting a pressure value from the surroundings and generating a detecting signal when the detected pressure value is larger than or equal to a predetermined pressure value;
an enclosure having a receiving portion for accommodating the pressure monitor;
a printed circuit board;
a battery providing electrical power for the printed circuit board; and
a power management module electrically connecting with the battery, the printed circuit board and the pressure monitor; the power management module cutting off electrical connection between the battery and the printed circuit board when receiving the detecting signal.

7. The mobile phone according to claim 6, wherein: the power management module comprises a trigger and an electronic switch; the electronic switch has two states: an open state and a close state; when the electronic switch is in the close state, an electrical connection between the battery and the printed circuit board is established; and when the electronic switch is in the open state, the electrical connection between the battery and the printed circuit board is discontinued.

8. The mobile phone according to claim 7, wherein the trigger generates a close trigger signal to the electronic switch when receiving the detecting signal and the electronic switch changes from the close state to the open state when receiving the close trigger signal.

9. The mobile phone according to claim 6, wherein: the mobile phone is substantially cubical; and the receiving portion is arranged on a sidewall of the mobile phone.
